(19) United States
(12) Patent Application Publication
(10) Pub. No.: US 2025/0123944 A1
(43) Pub. Date: Apr. 17, 2025

(54) SYSTEMS AND METHODS FOR ODATA API PERFORMANCE TESTING

(71) Applicant: SAP SE, Walldorf (DE)

(72) Inventors: Mohammad Jibran SOFI, Srinagar (IN); Shuva Ranjan Sen SHARMA, Bangalore (IN); Sourabh CHOUDHARY, New Delhi (IN)

(21) Appl. No.: 18/488,136

(22) Filed: Oct. 17, 2023

(51) Int. Cl. G06F 11/34; G06F 9/54

(52) U.S. Cl. CPC G06F 11/3495; G06F 9/54

(57) ABSTRACT

According to some embodiments, systems and methods are provided including an Application Programming Interface (API) source; a memory storing processor-executable program code; and a processing unit to execute the processor-executable program code to cause the system to: receive an API from the API source; insert one or more parameters into an endpoint of the API; execute, for a plurality of iterations, the API on a target system; receive performance data based on each of the plurality of executions of the API and the inserted one or more parameters; receive API information based on the inserted one or more parameters and an execution of the API; and display the performance information on a graphical user interface. Numerous other aspects are provided.

### BACKGROUND

An Application Programming Interface (API) is a type of software interface that allows two computers or two computer programs/applications to interact with each other without any user intervention. The API is a collection of software functions/procedures (code) that helps two different softwares communicate and exchange data with each other. The APIs are heterogeneous in terms of protocols, documentation and access mechanisms. Developers and other users at an organization may build APIs to allow end users to interact with and consume data from different applications. Often, before an API is released to the end user, the developer may want to assess the performance of the API. For example, in some instances, queries to the API are made by passing URLs via HTTP GET requests. While a response may be provided, details regarding performance may be unavailable. Systems and methods are desired which support performance testing of APIs.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a block diagram of an architecture according to some embodiments.

FIG. 2 is a flow diagram of a process according to some embodiments.

FIG. 3 is an outward view of a user interface according to some embodiments.

FIG. 4 is an outward view of a user interface illustrating an error notification according to some embodiments.

FIG. 5 illustrates a non-exhaustive example of a quality chart according to some embodiments.

FIG. 6 is an outward view of a user interface illustrating performance metrics according to some embodiments.

FIG. 7 is an outward view of a user interface illustrating performance metrics according to some embodiments.

FIG. 8 is an illustration of a spreadsheet that displays results of the analysis according to some embodiments.

FIG. 9 is a block diagram of an apparatus according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The disclosed embodiments relate to performance testing of application programming interfaces (APIs), and more specifically, APIs that are based on OData (“OData APIs”). Among other things, the solution framework in the disclosed embodiments facilitates efficient evaluation or measurement of performance of OData APIs.

An Application Programming Interface (API) is a software intermediary that, via a set of functions and procedures, allows two applications to communicate with each other. More particularly, the API acts as a messenger which takes a request from a requesting application to access the features or data of a target operating system, application or other service, delivers the request to the target, and returns a response to the requesting application. A non-exhaustive example of an HTTP-based API is an Open Data Protocol (OData). OData is a REST-based web protocol used to query and update data. OData is designed to provide standard Create Read Update and Delete (CRUD) access via HTTP(S) and provides for a synchronous request with a response. OData is built on technologies such as HTTP, Atom/XML, and JSON. It provides a uniform way to describe the data and the data model. It also defines a uniform way for creating, modifying, deleting and accessing data. OData allows a user to query a data source using a Hypertext Transfer Protocol (HTTP) and receive a result in a useable format. OData can be used to expose and access data from several types of data sources like databases, file systems, and websites.

As described above, before an OData API is released to an end user, and even while it is being developed, it may be desirable to assess the performance of the API to determine how quickly the data is being transferred from one place to another. Conventionally, an OData API may be performance tested, but only at a high level that measures the time it takes for the request to retrieve data from a target system and return the retrieved data to the requesting application.

Pursuant to some embodiments, an API performance testing module is provided to test the performance of OData APIs. When an API request is initiated by a source system, the OData API is not directly transmitted to the target application and instead is transmitted between one or more other elements on the way to the target application and back to the source system. Consider a real-world non-exhaustive example of someone's commute to work. Overall, it may take an hour to get from home to the office. However, the commute may be broken down further into a plurality of intervening sections between the home and the office. For example, the time it takes the person to walk from their house to the car may be a first section or leg, the time it takes the person to be at the car and then get inside the car may be a second section, the time it takes from the person being inside the car to start the car may be a third section, the time it takes from starting the car to traveling to the office may be a fourth section, etc. Similarly, in execution of the OData API, the OData API may be transmitted between multiple background components on the way to the target application. For example, the OData API may be initiated by the source system, and then is transmitted from the source system to a gateway server (first section), and from the gateway server to an application server (second section), and from the application server to the target application (third section), and back along the same path (e.g., from the target application to the application server, from the application server to the gateway server and from the gateway server back to the source system).

The OData API performance testing module may measure, as a non-exhaustive example, the time it takes for the request to result in returned data (e.g., the time of the overall trip the OData API takes from the source system until it returns to the source system), as well as the time it takes to execute each section of the trip. Then, based on those times, the OData API performance testing module may calculate values for additional performance standards (e.g., Key Performance Indicators (KPIs)) and compare those calculated values to thresholds associated with the KPIs. Non-exhaustive examples of calculated values are a front-end total, an application server total, a gateway server total, etc. The trip total, calculation values and output of the comparison may be reported to a user. The API performance testing module may provide real-time monitoring and reporting of key performance metrics, allowing users to identify and diagnose problems quickly. Additionally, the API performance testing module may provide a detailed analysis of time consumed by the different levels of OData API execution, which may help developers improve execution of the system. By providing better OData performance responsive to performance testing output, embodiments provide for a reduction in performance issues of execution of OData APIs.

In some examples, the embodiments herein may be incorporated within software that is deployed on a cloud platform.

The environments described herein are merely exemplary, and it is contemplated that the techniques described may be extended to other implementation contexts. As a non-exhaustive example, the performance testing may be expanded to test OData V4 calls and CRUD-based POST calls, etc.

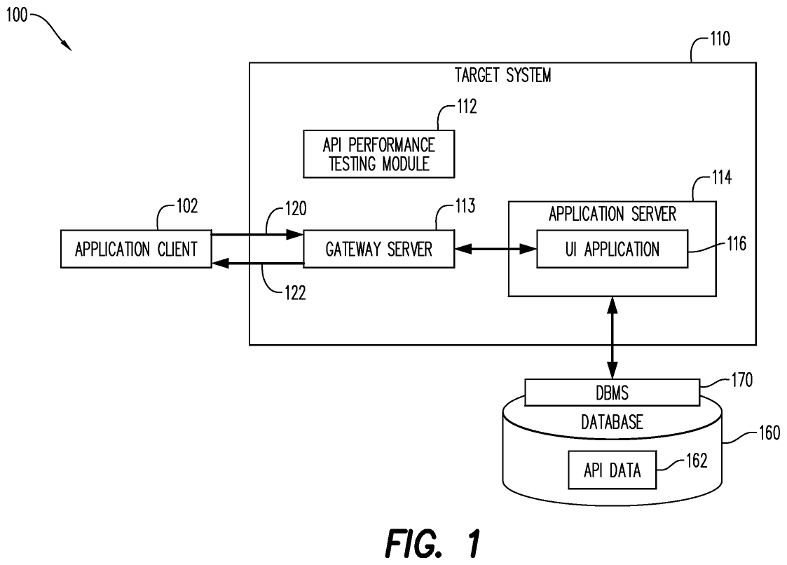

FIG. 1 is a block diagram of system architecture 100 according to some embodiments. The illustrated elements of system architecture 100 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of system architecture 100 are implemented by a single computing device, and/or two or more elements of system architecture 100 are co-located. One or more elements of system architecture 100 may be implemented using cloud-based resources, and/or other systems which apportion computing resources elastically according to demand, need, price, and/or any other metric.

System architecture 100 includes an application client 102, a target system 110, a database 160 and a database management system (DBMS) 170. The target system 110 comprise a test environment to test the performance of an OData API. The target system 110 may include an API performance testing module 112, a gateway server 113, an application server 114, and an application 116. Applications 116 may comprise server-side executable program code (e.g., compiled code, scripts, etc.) executing within application server 114 to receive queries/requests (e.g., API request) from application clients 102 and provide results to application clients 102 based on data of database 160 and the output of the API performance testing module 112. A client 102 may access the API performance testing module 112 executing within the target system 110, to perform an analysis and generate reports based on the analysis, as described further below.

Application client 102 may be at least one of a user interface program, a user interface server, another system or any other suitable device executing program code of a software application for presenting user interfaces (e.g., graphical user interface (GUI)) to allow interaction with the application (e.g., a UI application) 116. Presentation of a user interface may comprise any degree or type of rendering, depending on the type of user interface code generated by the application 116. For example, a client 102 may execute a Web Browser request and receive a Web page (e.g., in HTML format) via HTTP, HTTPS and/or WebSocket, from an application 116 to provide the UI, and may render and present the Web page according to known protocols. The application client 102 may also or alternatively present user interfaces by executing a standalone executable file (e.g., an .exe file) or code (e.g., a JAVA applet) within a virtual machine.

The API performance testing module 112 may provide a user interface, which the application client will use to pass an OData API URL to the module 112 to retrieve performance statistics for the execution of the OData API. It is noted that the user may only need to provide the OData API URL, without providing further authentication of headers for the OData API URL. The API performance testing module 112 may test any working OData URL. The API performance testing module 112 may receive the OData API URL (“URL”), and may authenticate the URL and provide required headers to execute the URL tests. The API performance testing module 112 may execute the URL a pre-defined number of iterations (e.g., 17), without receiving further input from the user beyond the initial input of the OData API URL. Once execution of all of the iterations is complete, the API performance testing module 112 may retrieve statistics across all of the iterations, average the statistics and perform calculations based on the retrieved and averaged statistics. The API performance testing module 112 internally calls a service exposed on a system to retrieve a service quality of the OData API. Once the service quality of the OData API is known, the API performance testing module 112 compares the retrieved and calculated values with thresholds set for performance of OData APIs and in some instances based on the service quality. The API performance testing module 112 may then output a test report which contains the test results and test status. The test results may then be transmitted back to a UI at the client 102. As will be described further below, the test results provided on the UI may include the service and entity used for the test, its measurement quality, and the average values of the measured statistics like response time, etc. The test results provided on the UI may also include the test status (“OK” or “Not OK”). The API performance testing module 112 may also provide a hint that points to the source that consumes the most time of the trip, and in the case of the “Not OK” test status, this may be the source of the “Not OK” test status. It is noted that in a case of an “OK” test status, this most time consuming source may indicate a place for further optimization. A user may also be able to download a detailed report that contains statistics for all of the test iterations via selection of a download report link on the test result UI. Pursuant to some embodiments, no maintenance of the API performance testing module 112 is needed as buffered runs are implicitly handled by the module 112, as described further below.

The gateway server 113 acts as a middleman, transforming data streams between the client 102 and the application server 114 to better match device capabilities. The transformation by the gateway server 113 provides content to the client 102 who may otherwise be unable to access the application server 114 and vice versa. Pursuant to some embodiments, the gateway server may impose additional security restrictions on the client 102.

Application server 114 provides any suitable interfaces through which the clients 102 may communicate with the API performance testing module 112 or applications 116 executing on application server 114. For example, application server 114 may include a HyperText Transfer Protocol (HTTP) interface supporting a transient request/response protocol over Transmission Control Protocol/Internet Protocol (TCP/IP), a WebSocket interface supporting non-transient full-duplex communications which implement the WebSocket protocol over a single TCP/IP connection, and/or an Open Data Protocol (OData) interface.

One or more applications 116 executing on application server 114 may communicate with DBMS 170 using database management interfaces such as, but not limited to, Open Database Connectivity (ODBC) and Java Database Connectivity (JDBC) interfaces. These types of applications 116 may use Structured Query Language (SQL) to manage and query data stored in database 160.

DBMS 170 serves requests to retrieve and/or modify data of database 160, and also performs administrative and management functions. Such functions may include snapshot and backup management, indexing, optimization, garbage collection, and/or any other database functions that are or become known. DBMS 170 may also provide application logic, such as database procedures and/or calculations, according to some embodiments. This application logic may comprise scripts, functional libraries and/or compiled program code. DBMS 170 may comprise any query-responsive database system that is or becomes known, including but not limited to a structured-query language (i.e., SQL) relational database management system.

Application server 114 may be separated from, or closely integrated with, DBMS 170. A closely integrated application server 114 may enable execution of server applications 116 completely on the database platform, without the need for an additional application server. For example, according to some embodiments, application server 114 provides a comprehensive set of embedded services which provide end-to-end support for Web-based applications. The services may include a lightweight web server, configurable support for OData, server-side JavaScript execution and access to SQL and SQLScript.

Application server 114 may provide application services (e.g., via functional libraries) which applications 116 may use to manage and query the data of database 160. The application services can be used to expose the database data model, with its tables, hierarchies, views and database procedures, to clients. In addition to exposing the data model, application server 114 may host system services such as a search service.

Database 160 may store data used by at least one of: applications 116 and the API performance testing module 112. For example, database 160 may store data 162 accessed by the API performance testing module 112 during execution thereof.

In some embodiments, the data 162 may comprise one or more of conventional tabular data, row-based data, column-based data, and object-based data. Moreover, data 162 may be indexed and/or selectively replicated in an index to allow fast searching and retrieval thereof. Pursuant to embodiments, the data 162 may include storage of all OData URLs and respective performance metrics in a persistency layer which may be later referred to in order to analyze regressions.

OData services expose an end point that allows UI application 116 to access data 162 in database 160. OData services implement the OData protocol and map data 162 between its underlying form (e.g., database tables, spreadsheet lists, etc.) and a format that the requesting client can understand.

OData defines an abstract data model and a protocol which, together, enable any client to access data exposed by any data source via a Uniform Resource Indicator (URI). The data model provides a generic way to organize and describe data. A GET request may list details and URIs of the resources in a collection and retrieve a specific item in the collection.

Database 160 may comprise any query-responsive data source or sources that are or become known, including but not limited to a structured-query language (SQL) relational database management system. Database 160 may comprise a relational database, a multi-dimensional database, an extensible Markup Language (XML) document, or any other data storage system storing structured and/or unstructured data. The data of database 160 may be distributed among several relational databases, dimensional databases, and/or other data sources. Embodiments are not limited to any number or types of data sources.

In some embodiments, the data of database 160 may comprise one or more of conventional tabular data, row-based data, column-based data, and object-based data. Moreover, the data may be indexed and/or selectively replicated in an index to allow fast searching and retrieval thereof. Database 160 may support multi-tenancy to separately support multiple unrelated clients by providing multiple logical database systems which are programmatically isolated from one another.

Database 160 may implement an “in-memory” database, in which a full database is stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently used data) and one or more fixed disks (e.g., persistent memory for storing their respective portions of the full database).

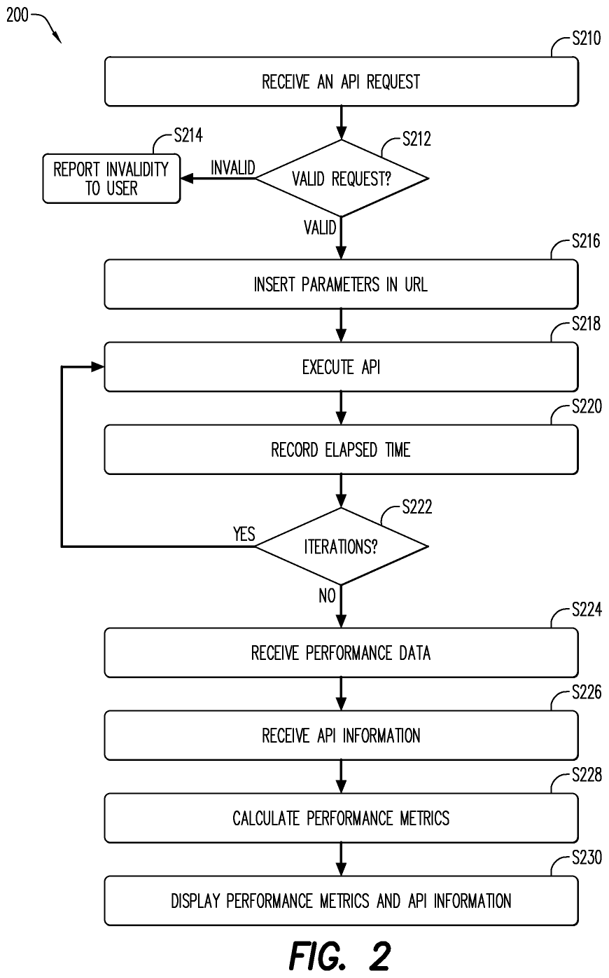

Reference is now made to FIGS. 2-8, which will be discussed together.

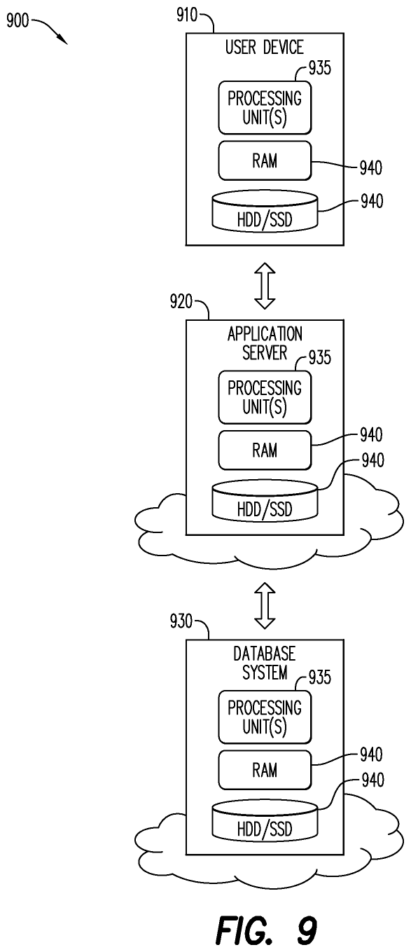

FIG. 2 illustrates a process 200 for testing the performance of OData APIs in accordance with an example embodiment. The process 200 may be performed by a database node, a cloud platform, a server, a computing system (user device), a combination of devices/nodes, or the like, according to some embodiments. In one or more embodiments, the target system 110 may be conditioned to perform the process 200 such that a processing unit 935 (FIG. 9) of the system architecture 100 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

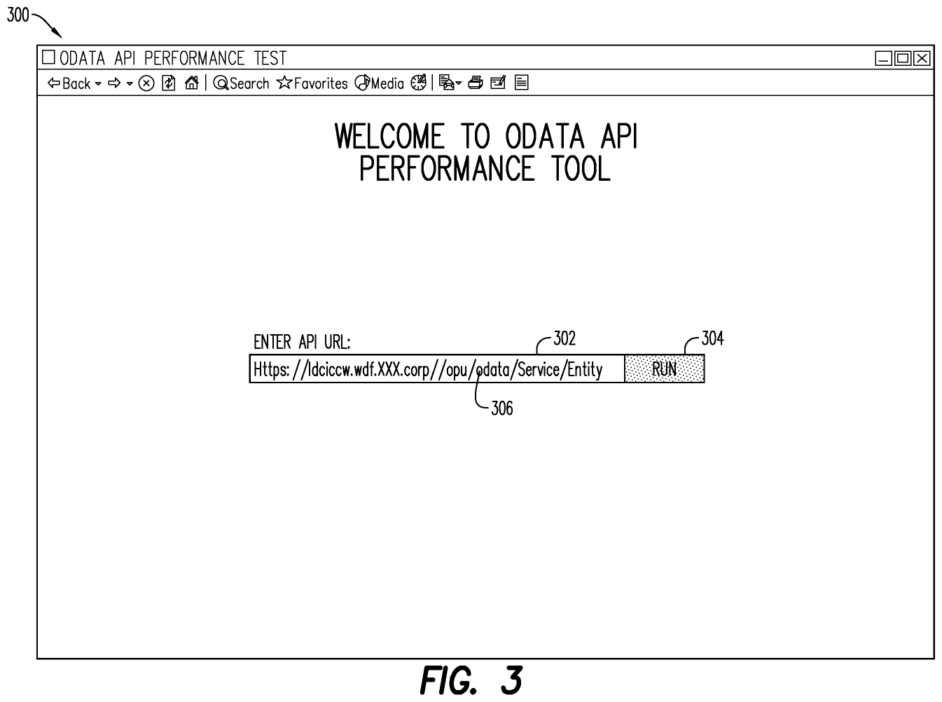

Prior to the process 200, a user may access the API performance testing module 112 via the application client 102 and be provided with a dashboard display 300 in accordance with some embodiments, as described below with respect to FIG. 3. The dashboard display 300 may include an API URL data entry field 302 and a user selectable control 304 (e.g., “Run” control). Selection of the user selectable control 304 may execute the performance test of a value (URL) 306 entered in the data entry field 302. While herein the user selectable control is a button icon, other suitable controls may be used. A user may be, as a non-exhaustive example, an application developer creating an application. For an application to work, data transfer occurs, and that data transfer may be via OData URLs. The user, who is internally testing the developing application, may enter one of the URLs for that application in the API URL data entry field 302. It is noted that it may be desirable to test the URLs as they are being created instead of waiting for the entire application to be completed to better-manage trouble-shooting and load on the system. In other embodiments, the user may test an OData API that is public and stored in an API repository or other storage.

Initially, at S210 an API request/call 120 is received from an API source (e.g., the application client 102). The API request 120 is received in response to selection of the user selectable control 304. As described above, an API is a set of rules that allow two applications to share resources and the API request 120 is a message sent to a server asking for information (resource). Here, the API is based on an Open Data Protocol (OData) and is an “OData API”. Further the API request may include an API endpoint, which is a specific location of resources. The API uses endpoint Uniform Resource Locators (URL) s to retrieve the requested resources per the API request. While herein the endpoint may be referred to as a URL, it is noted that other Uniform Resource Identifier (URIs) may be used as the API endpoint. Herein, the OData API may be a private API in that this API is not publicly searchable. The API may be private because it is still under development.

Then in S212 it is determined whether the API request 120 is valid. Pursuant to some embodiments, the API performance testing module 112 may use a table look-up (e.g., listing resources available for testing) or other suitable mechanism to determine API request validity.

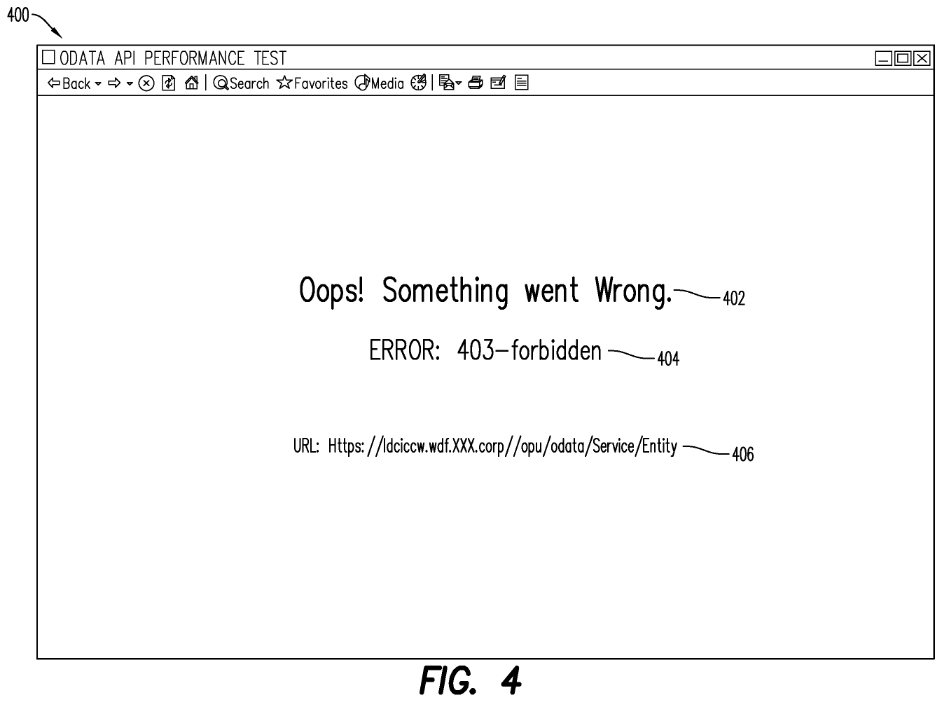

In a case the API request 120 is invalid, the process proceeds to S214 and reports the invalidity to the user. As non-exhaustive examples, the invalidity may be due to the URL being incorrectly entered, unavailable for testing, etc. An error notification user interface (UI) 400 (FIG. 4) may be rendered in response to the invalidity determination to report the invalidity to the user. The error notification UI 400 may include a notification that an error occurred 402, an error description 404, and the URL entered (“entered URL”) 406 in the data entry field 302 of the dashboard display 300.

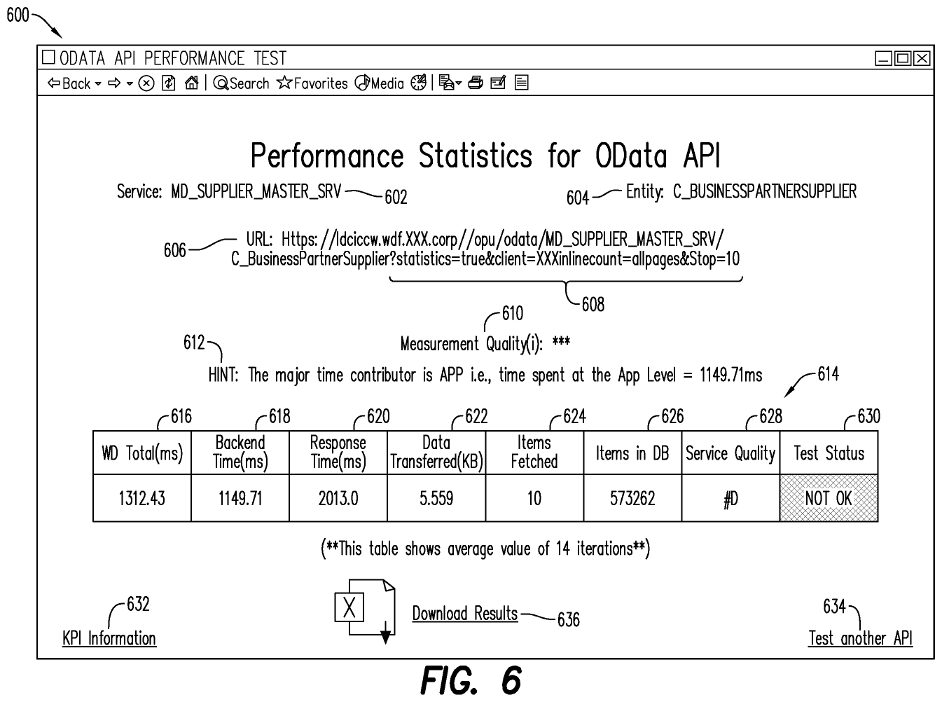

In a case the API request 120 is valid, the process proceeds to S216 and the performance testing module 112 inserts one or more parameters 608 (FIG. 6) into the URL. The parameters 608 may further instruct the OData API to retrieve particular values related to performance metrics for the URL. As a non-exhaustive example, the parameter 608 may be “statistics=true”. The “statistics=true” parameter may return values for each leg of the cycle. As used herein, the terms “cycle” and “trip” may be used interchangeably. As described above with respect to the real-world example, “statistics=true” may return the time it takes to get from home to the car, the time it takes to get from outside the car to inside the car, etc. As another non-exhaustive example, the parameter 608 may be to retrieve the total number of items existing in the persistency layer or in the database, and/or to retrieve a service quality score, etc. As yet another non-exhaustive example, the parameter 608 may be “inline count=all pages,” which may return a count of the number of entities in the collection (e.g., in this case the collection is all of the pages). It is noted that having the API performance testing module 112 add the parameters allows the user to provide a simpler URL to the dashboard display for testing. Further, conventional performance testing systems may not retrieve these inserted parameters due to the challenges of retrieving this information from different components of the backend (target system) which different technical terminologies. Another challenge of conventional performance testing is a user needs to manually trigger each iteration and review the performance data associated with each iteration.

Then in S218, the OData API (e.g., API endpoint (URL)) is executed. Pursuant to embodiments, execution of the URL includes transmission of the API call 120 from an initial point (e.g., the application client 102) to the target system (e.g., UI application 116 of application server 114), and transmission of an API response 122 (e.g., acknowledgement) from the target system to the initial point. Execution of the URL includes transmission of the OData API across a plurality of legs during the transmission to the target system and back to the initial point. The transmission from the initial point and back to the initial point may be referred to herein as a “cycle.” Each leg may include at least one intermediate point. As a non-exhaustive example, the intermediate point may be the gateway server 113 and the application server 114. As shown in FIG. 1, from the application client 102 to the intermediate point of the gateway server 113 is a first leg. From the intermediate point of the gateway server 113 to the application server 114 is a second leg. While at the application server, the API call 120 is transmitted to the database 160 to retrieve data per the UI application 116. The transmission of the API call 120 to the intermediate point of database 160 is a third leg. Then, after the data is retrieved, the data is returned to the application server 114 from the database (fourth leg) as an API response 122. From the application server 114, the API response is transmitted to the gateway server 113 (fifth leg) and then finally transmitted to the application client (6^{th} leg).

The elapsed time for each leg is recorded in S220, based on the inserted parameters 608. The elapsed time for each leg ma be measured as the amount of time from when the API transmission arrives at the leg until it leaves the leg. For example, the time from when the API call 120 leaves the client 102 and arrives at the gateway server 113 is the elapsed time for one leg; the time from when the API call 120 arrives at the gateway server 113 until it arrives at the application server 114 is another leg; the time from when the API call 120 arrives at the application server 114 until it arrives at the database 160 is another leg; and the time the API call arrives at the database and returns an API response 122 to the application server 114 is another leg.

Then in S222 it is determined whether any iterations (e.g., executions of the OData API) of the OData API remain to be performed. Each OData API is executed more than once. The number of iterations may be pre-set by an administrator or other party. The following will be described with respect to executing the OData API 17 times, but another number of iterations may be used. The elapsed time for each leg for the first several iterations (e.g., three) may not be recorded, as the UI application may be in a buffering-type mode and the elapsed time may not be accurate. The performance (e.g., elapsed time) is then measured and recorded for the fourth iteration through the seventeenth iteration. It is noted that the cycle is repeated (iterated) more than once to account for latency or other factors that may affect the elapsed time for each leg. For example, for one or more iterations there may be another load-unrelated to the performance test-on one or more of the gateway server/application server during the iteration and this load may affect the elapsed time.

In a case there are iterations remaining, the process returns to S218.

In a case there are no iterations remaining, the process proceeds to S224 and the API performance testing module 112 receives performance data based on each of the plurality of executions of the OData API and the inserted one or more parameters 608. The performance data may include for each iteration, but is not limited to, a gateway time, a backend time, a total response time (elapsed execution time for the OData API) and a data transferred value. It is noted that the response time is a measure of the runtime and the basis of the time taken from the call being sent to receiving the response. The gateway total and backend time may be based on other statistics (both direct and calculated) per the inserted parameters 608. In some embodiments, the performance data may include for each iteration, but is not limited to, a front end total (FW), an app total (APP), a gateway total (GW), a gateway-front end total (GWFW), a gateway-app total (GWAPP) and a gateway-backend total (GWBE).

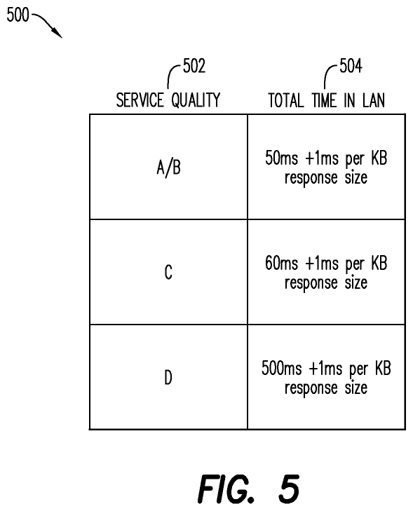

Then in S226, the API performance testing module 112 receives API information based on the inserted one or more parameters and execution of an iteration of the OData API. The API information may include, but is not limited to, a number of items fetched from the database 160 by the OData API, a total number of items in the database, and a service quality score 502 (FIG. 5).

A service quality score 502 is associated with each URL. As described further below, each URL includes a service and an entity to return data. The service quality refers to the quality provided by that particular row data service. A service quality score 502 is used by the API performance testing module 112 to determine whether the performance test indicates execution of a particular OData API is “OK” or “Not OK”. Based on the service quality score 502 and data transferred, a particular value is calculated for comparison to a threshold, and the given threshold is based on the service quality score. For example, a service quality score 502 of D uses a particular calculation and threshold that are different than those used for a service quality score 502 of C.

The service quality score 502 is pre-defined by the target system and is based on the number of items in a database and the number of tables in the database that need to be accessed to retrieve the information. The service quality score 502 may be thought of as a complexity given to a particular view, and based on that particular score, a threshold of performance is defined. The service quality score 502 is based, to some extent, on the amount of data transferred by the OData API. Consider, for example, a URL that has to only look at ten items to fetch two items. Comparing a response time of that URL to a URL that has to look at 10,000 items to fetch two items is not an equal comparison. To avoid the inequity, service quality score 502 may be used. As a non-exhaustive example, FIG. 5 provides a mapping 500 of a service quality score 502 to a total time 504 in Local Area Network. Here, a service quality score 502 of A/B is assigned to a total time of 50 ms+1 ms per KB of response size; C is assigned to a total time of 60 ms+1 ms per KB of response size; and D is assigned to a total time of 500 ms+1 ms per KB of response size. It is noted that other calculations may map to different quality scores. As a non-exhaustive example based on the mapping 500 of FIG. 5, if a URL is assigned a service quality score of D, the formula used per the mapping 500 is 500+1 ms per KB of response size. Continuing with this example, 10 items are fetched and are 200 KB. As such, the overall threshold for completing that particular fetch should be 700 ms, which is 500+(1*200). If a particular OData API execution has a response time of 800 ms, it breaches that 700 ms threshold, and the OData API may be reported as “NOT OK”.

Next, in S228, performance metrics are calculated based on the performance data and the API information. The performance metrics may be calculated in real-time. Pursuant to embodiments, a non-exhaustive example of a performance metric is the Test status 630 (FIG. 6), and a measurement quality 610 (FIG. 6) described further below.

The performance data, performance metrics and API information may be displayed on a graphical user interface in S230.

FIG. 6 is an example of a Performance Statistics User Interface (UI) display 600 (“display”) in accordance with some embodiments. The display 600 may include a service parameter 602 and an entity parameter 604. The service parameter 602 may indicate a row data service that accesses or calls data, and the entity is a set of related attributes/field values. They are received as part of the entered API URL 306 shown in FIG. 3, and are required for the API URL to return data. The Performance Statistics UI display 600 also includes the modified URL 606 including the inserted parameters 608. A measurement quality 610 may be calculated in real-time and indicates whether there is too much of a gap between one iterative value to another. For example, if the value is five stars, the standard deviation across may be less than 15% and the results are pretty close together (e.g., there will be some difference but it is very minimal). Here, the Measurement Quality is three stars, indicating there is some appreciable difference between the iterative values. A hint 612 may indicate the biggest contributor to the elapsed time. Here, the biggest contributor is time spent at the APP (application) level. The indication of the biggest contributor may inform a developer of where improvements may be made to decrease the total time spent in execution of the OData API and, in some instances, may suggest a location that may be responsible for a “Not OK” Test status 630.

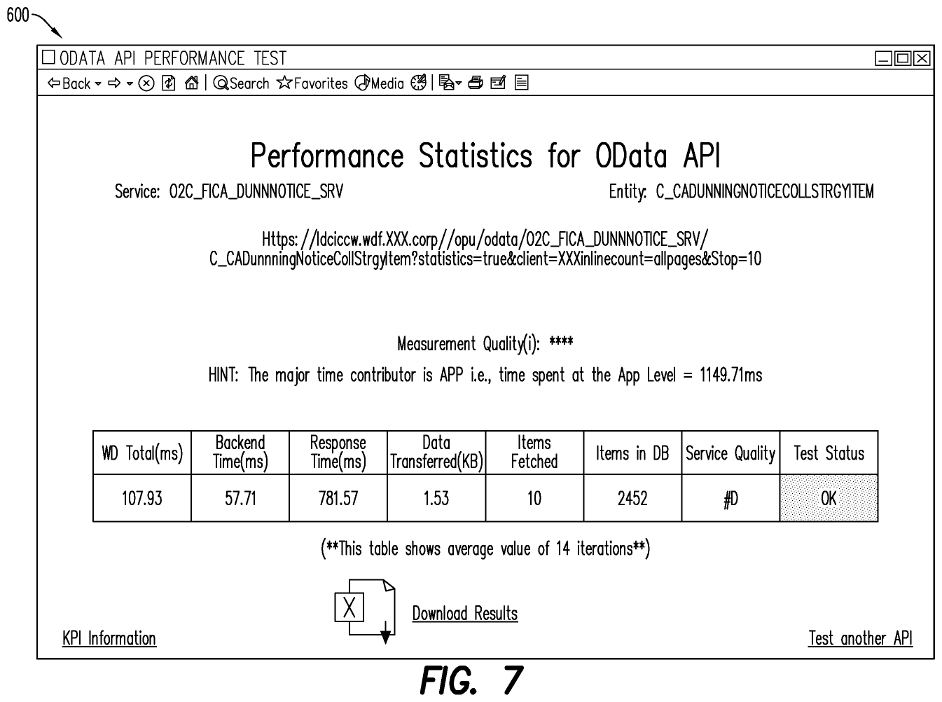

The display 600 may also include a table 614 including performance metrics, API information and performance data. It is noted that the information in the table 614 is the average of the iterations (in this case 14 iterations). The table 614 includes the following parameters: WD (Gateway) Total 616, a Backend Time 618, a Response Time 620, a Data Transferred 622, an Items Fetched 624, an Items in DB 626, a Service Quality 628 and Test Status 630. As described above, the response time is a measure of the runtime and the basis of the time taken from the call being sent to receiving the response. The gateway total and backend time may be based on other statistics (both direct and calculated) per the inserted parameters 608. Display 600 gives overview of performance stats. The Test Status (“OK” or “NOT OK”) may be based on the Response Time exceeding the threshold per the Service Quality calculation. Here, the Test Status 630 is “NOT OK”. FIG. 7 provides the Performance Statistics User Interface (UI) display 600 for a different URL as compared to the one included in FIG. 6. In this non-exhaustive example shown in FIG. 7, the Test Status 630 is “OK”.

The Performance Statistics UI display 600 may also include a KPI Information link 632 and a “Test Another API” link 634. Selection of the KPI Information link 632 may provide more information regarding the threshold and other indicators. Selection of the “Test Another API” link 634 may return the user to the dashboard display 300 of FIG. 3

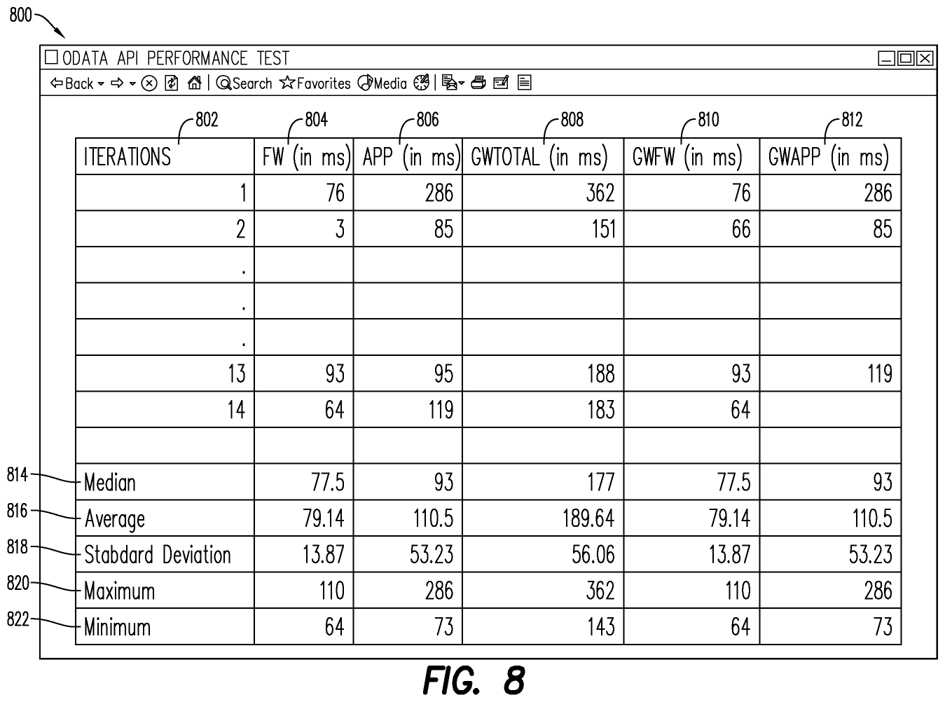

A user may select a Download Results link 636 to receive more information for each iteration, as shown in the chart 800 of FIG. 8. The chart 800 may include measurements for each executed iteration 802 for which results are recorded. The fields may include, but are not limited to, Front End (FW) 804, Application Level 806, Gateway Total 808, Gateway and Front End Total 810 and a Gateway and Application Level 812. The chart 800 may also include, across all iterations, and for each field, a median 814, an average 816, a standard deviation 818, a maximum 820 and a minimum 822.

FIG. 9 illustrates a cloud-based database deployment 900 according to some embodiments. The illustrated components may reside in one or more public clouds providing self-service and immediate provisioning, autoscaling, security, compliance and identity management features.

User device 910 may interact with applications executing on the application server 920 (cloud or on-premise), for example via a Web Browser executing on user device 910, in order to create, read, update and delete data managed by database system 930. Database system 930 may store data as described herein and may execute processes as described herein to cause the execution of the API performance testing module 112 for use with the user device 910. Application server 920 and database system 930 may comprise cloud-based compute resources, such as virtual machines, allocated by a public cloud provider. As such, application server 920 and database system 930 may be subjected to demand-based resource elasticity. Each of the user device 910, application server 920, and database system 930 may include a processing unit 935 that may include one or more processing devices each including one or more processing cores. In some examples, the processing unit 935 is a multicore processor or a plurality of multicore processors. Also, the processing unit 935 may be fixed or it may be reconfigurable. The processing unit 935 may control the components of any of the user device 910, application server 920, and database system 930. The storage devices 940 may not be limited to a particular storage device and may include any known memory device such as RAM, ROM, hard disk, and the like, and may or may not be included within a database system, a cloud environment, a web server or the like. The storage devices 940 may store software modules or other instructions/executable code which can be executed by the processing unit 935 to perform the method shown in FIG. 2. According to various embodiments, the storage device 940 may include a data store having a plurality of tables, records, partitions and sub-partitions. The storage device 940 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A system comprising:
an Application Programming Interface (API) source;
a memory storing processor-executable program code; and
a processing unit to execute the processor-executable program code to cause the system to:
receive an API from the API source;
insert one or more parameters into an endpoint of the API;
execute, for a plurality of iterations, the API on a target system;
receive, from a target system, performance data based on each of the plurality of executions of the API and the inserted one or more parameters;
receive API information based on the inserted one or more parameters and an execution of the API; and
display the performance data and API information on a graphical user interface.

2. The system of claim 1, wherein the API is based on Open Data Protocol (OData).

3. The system of claim 1, wherein execution of the API includes program code to cause the system to:
transmit an API call from an initial point to the target system; and
transmit an API response from the target system to the initial point.

4. The system of claim 3, wherein execution of the API includes transmission of the API across a plurality of legs.

5. The system of claim 4, wherein each leg includes at least one intermediate point.

6. The system of claim 5, wherein the intermediate point comprises a gateway server and an application server.

7. The system of claim 6, wherein the application server is configured to:
access a database;
retrieve data from the database; and
generate the API response including the retrieved data.

8. The system of claim 4, further comprising program code to cause the system to:
record, based on the one or more inserted parameter, an elapsed time for API transmission for each leg.

9. The system of claim 4, wherein the performance data includes an elapsed execution time for the API.

10. The system of claim 9, wherein the performance data includes an average over the plurality of iterations.

11. The system of claim 10, further comprising program code to cause the system to:
calculate one or more performance metrics based on the performance data and the API information.

12. The system of claim 11, wherein the API information includes a number of items fetched from a database, a total number of items in the database, and a service quality score.

13. A computer-implemented method comprising:
receiving an Application Programming Interface (API) from an API source, wherein the API is based on Open Data Protocol (OData);
inserting one or more parameters into an endpoint of the API;
executing, for a plurality of iterations, the API;
receiving performance data from a target system based on the plurality of executions of the API and the inserted one or more parameters;
receiving API information based on the inserted one or more parameters and an execution of the API;
calculating one or more performance metrics based on the received performance data and the received API information;
and
displaying the performance metrics, performance data and API information on a graphical user interface.

14. The method of claim 13, wherein execution of the API includes transmission of the API across a plurality of legs.

15. The method of claim 14, wherein each leg includes at least one intermediate point.

16. The method of claim 15, wherein the intermediate point comprises a gateway server and an application server.

17. The method of claim 14, further comprising:
recording, based on the one or more inserted parameters, a time taken for API transmission for each leg.

18. A non-transitory computer readable medium having executable instructions stored therein to perform a method, the method comprising:
receiving an Application Programming Interface (API) from an API source, wherein the API is based on Open Data Protocol (OData);
inserting one or more parameters into an endpoint of the API;
executing, for a plurality of iterations, the API on a target system;
receiving performance data from a target system based on the plurality of executions of the API and the inserted one or more parameters;
receiving API information based on the inserted one or more parameters and an execution of the API;
calculating one or more performance metrics based on the received performance data and the received API information;
and
displaying the performance metrics, performance data and API information on a graphical user interface.

19. The medium of claim 18, wherein execution of the API includes transmission of the API across a plurality of legs.

20. The medium of claim 19, further comprising:
recording, based on one or more inserted parameters, a time taken for API transmission for each leg.
